(19) United States
(12) Patent Application Publication
(10) Pub. No.: US 2026/0159444 A1
(43) Pub. Date: Jun. 11, 2026

(54) METHOD OF PRODUCING CEMENT CLINKER FROM A SOURCE OF CALCIUM SULFATE

(71) Applicant: Amrize Technology Switzerland LLC, ZUG (CH)

(72) Inventors: Stefan DIETZ, HOLDERBANK (CH); Karl-Heinz BOES, HOLDERBANK (CH); Beat STOFFEL, HOLDERBANK (CH); Laurent SEYLER, HOLDERBANK (CH)

(21) Appl. No.: 19/126,887

(22) PCT Filed: Oct. 31, 2023
(86) PCT No.: PCT/IB2023/060943

§ 371 Date: May 2, 2025

(30) Foreign Application Priority Data
Nov. 2, 2022 (EP) 22020527.2

(51) Int. Cl. C04B 7/17; C04B 7/04; C04B 7/24; C04B 7/26; C04B 7/47

(52) U.S. Cl. CPC C04B 7/17; C04B 7/04; C04B 7/246; C04B 7/26; C04B 7/47

(57) ABSTRACT

A method of producing cement clinker from a source of calcium sulfate, includes calcining the source of calcium sulfate in the presence of a reducing agent in a first reactor to obtain calcium oxide and sulfur dioxide and withdrawing the calcium oxide from the first reactor, and subsequently adding silica, alumina and iron oxide to the calcium oxide to obtain a raw material mixture and calcining the raw material mixture in a second rector to obtain cement clinker.

The invention refers to a method of producing cement clinker from a source of calcium sulfate.

The production of Portland clinker is traditionally done by preparing a raw meal that comprises limestone and raw clays, and calcining this raw material in a rotary kiln at a temperature of around 1′450° C. During this calcination step, the calcium carbonate in the limestone decarbonates to form carbon dioxide and calcium oxide. Furthermore, the rotary kiln used for the production of Portland clinker is heated by a burner, which produces heat from burning carbon containing materials, such as fuels and waste materials, which also produces carbon dioxide. These two processes run simultaneously in a Portland clinker manufacturing plant, and produce high amounts of carbon dioxide.

An alternative method of production of Portland clinker that does not require the use of calcium carbonate materials is based on the Müller Kühne (MK) process, wherein a source of calcium sulfates is used as a starting material. In the MK-process calcium sulfate, for example in the form of gypsum, is reduced to calcium sulfide which reacts with calcium sulfate to give sulfur dioxide and calcium oxide, the latter being the main material to obtain cement. The MK-process takes place at temperatures of around 800° C. and requires a source of carbon, which acts as a reducing agent. The calcium oxide resulting from the MK-process is further processed to obtain cement clinker.

US 2022/0204403 A1 discloses a method of producing cement and co-producing sulfuric acid from phosphogypsum.

EP 728713 B1 discloses a process where calcium sulfate materials are mixed with reactive carbon, and calcined at a first temperature of over 700° C. so as to obtain calcium oxide, and the calcium oxide is then calcined at a temperature of over 1200° C. in the presence of silica, alumina and iron oxide to obtain clinker. The SO₂ containing flue gas is then treated to be converted to SO₃ to produce sulfuric acid.

De 19625538 B4 discloses a method of producing Portland cement and sulfuric acid by the MK-process, wherein waste gypsum board and other gypsum rubble are used as a source of calcium sulfate. The waste gypsum boards are pre-reduced to a uniform mill-processable edge length, sorted and freed from foreign materials such as wood, steel and plastic pieces, ground to powder fineness under throttled air suction, mixed with other cement starting material powder components and, after optional intermediate storage, processed in the rotary kiln to form cement clinker.

In the known methods of producing cement based on the MK-process, silica, alumina and iron oxide are added to the process. These additional components are required in addition to the calcium oxide produced during the process so that the mixture that is further processed at high temperatures has an overall composition that is suitable for the production of Portland clinker.

However, conducting the MK-process in the presence of silica, alumina and iron oxide has limitations in setting the optimum process conditions, such as atmosphere and temperature, so that the clinker product quality may be impaired and operation costs are elevated. In particular, sulfate circuits may arise, meaning that operational issues will occur such as kiln stops, triggered for example by blockages from material build-ups. Further, different temperature levels should be adjusted for the MK-process on the one hand and for the subsequent calcination of calcium oxide as well as silica, alumina and iron oxide to form clinker on the other hand.

Therefore, the instant invention aims at improving a method of producing cement clinker based on the MK-process.

In order to solve this and other objects, the invention provides a method of producing cement clinker from a source of calcium sulfate, comprising:
a first step of calcining the source of calcium sulfate in the presence of a reducing agent in a first reactor to obtain calcium oxide and sulfur dioxide and withdrawing the calcium oxide from the first reactor, and subsequently
a second step of adding silica, alumina and iron oxide containing materials to the calcium oxide to obtain a raw material mixture and calcining the raw material mixture in a second rector to obtain cement clinker.

Thus, the invention is based on the idea to carry out the transformation of a calcium sulfate source into a cement clinker in a two-step process, and to conduct each step in a separate subsequent reactor. In this way, each step may be optimized with respect to its process conditions, including atmosphere and temperature. The first step of the method is based on the MK-process and is carried out to obtain calcium oxide and the process conditions of the first step can be adjusted to the requirements of the process, such as lower temperature than in the second step and a reducing atmosphere. Further, the first step may be improved with regard to the proper separation of sulfur dioxide from the calcium oxide. In this way, less or no sulfate will be entrained into the second step and the resulting cement clinker will have a reduced saturation with sulfate. Further, the entrainment of any unreacted calcium sulfate into the second step may be reduced or eliminated, resulting in a cement having a lower content of calcium sulfate.

Since an optimal temperature may be adjusted for each of the first and second steps, the energy efficiency of the overall process is increased.

Another advantage of the two-step process of the invention is that calcium oxide is obtained as an intermediate product after the first step, so that at least a partial amount of the calcium oxide may be used for another purpose than the second step. For example, calcium oxide may be used for the mineralization of CO₂ or the capture of sulfates that could be emitted by the process.

Further, with the two-step process the generation of the intermediate product can be controlled very well, e.g. by controlling the dosage of the reducing agent, the sulfur content, the CaSO₄ retention time and the temperature, therefore a higher quality clinker may be achieved in the second step.

Also, the two steps of the process can be carried out at different geographical locations, considering the availability and/or the market for gypsum, sulfuric acid, CO₂ and the final clinker product.

Since the additional materials needed in the raw material composition for the production of Portland clinker, namely silica, alumina and iron oxide, are added to the process only in the second step, the first step may be carried out without the presence of these additional materials. The second step may be optimized to calcine the raw material mixture in a suitable embodiment of the second rector to obtain cement clinker.

In a preferred embodiment, the sources of silica, alumina and iron oxide comprise recycled or waste materials. In a preferred embodiment, the sources of silica, alumina and iron oxide comprise at least 40 wt. -% of recycled or waste materials.

The recycled or waste materials can be selected from any of the following materials: mineral waste materials from construction and demolition such as concrete demolition waste, recycled aggregates, recycled bricks, coal ashes, or steel slags.

The use of waste and recycled materials decreases the environmental impact of this production process, by minimizing the need to use virgin materials.

As to the control of the temperature in the two steps of the method of the invention, a preferred embodiment provides that the calcination of the first step is carried out at a temperature of 700-1300° C. and the calcination of the second step is carried out at a temperature of 1340-1450° C., wherein the second step is preferably carried out at higher temperature than the first step. Preferably, the temperature used in the second step is at least 100° C. higher than in the first step.

Various sources of calcium sulfate may be used as a starting material for the MK based process carried in the first step. In particular, the source of calcium sulfate may be gypsum, anhydrite, hemihydrate, waste calcium sulfate and/or phosphogypsum, the latter being widely available as it is most often landfilled in large quantities, being a by-product of the production of phosphate-based fertilizers or phosphoric acid.

In order to maximize the surface to volume ratio of the calcium sulfate source, thereby increasing the efficiency of the reaction between the calcium sulfate source and the reducing agent during the MK-process, the source of calcium sulfate is preferably introduced into the first reactor in the form of a powder, preferably having a maximum particle size of 300 μm. Herein, the particle size is measured by sieving.

Considering that some sources of calcium sulfate have a high water content, a preferred embodiment of the invention provides that the source of calcium sulfate is dried (dehydrated) to a water content of <2 wt. -%, preferably less <1 wt. -%, before being introduced into the first reactor.

For the MK-process to be conducted in an efficient way, the first step preferably is carried out in a reducing atmosphere, wherein the oxygen content is preferably below 0.7 vol. -%.

The reducing agent may preferably be a source of carbon in solid form, such as coal in powder form (e.g. mineral coal, coke, charcoal or even plant coal). In case a source of carbon is used as the reducing agent, the flue gas exiting the first reactor comprises a high concentration of carbon dioxide and sulfur dioxide. Other reducing agents can be metal powders, such as calcium, aluminum, silicium, iron, or mixtures thereof. Another option is the use of hydrogen. The sulfur dioxide is separated from the gas, for example by a scrubber, to form sulfuric acid, which is a by-product of the present process that can be made further use of in other industrial applications. When the first step comprises an oxyfuel combustion process, in which additional oxygen is injected into the burner, the carbon dioxide extracted from the process has a higher level of purity and can easily be used in other applications or sequestered.

As mentioned above, the invention provides a two-step process, wherein the first and the second step are carried out in two different and separate reactors. Preferably, the first reactor is designed as a flash calciner, which preferably is operated so that the material retention times are of 3-8 seconds, rotary calciner, fluidized bed reactor, or shaft reactor.

The second reactor may preferably be designed as a rotary kiln. In particular, an existing rotary kiln of a cement manufacturing plant may be used.

In order to prevent sulfur compounds obtained in the first step of the method of the invention from being entrained into the second step, the sulfur dioxide is separated from the calcium oxide, before the calcium oxide is fed to the second step.

As mentioned before, an advantage of the present invention is the greater flexibility as to the use of the calcium oxide obtained from the first step, since it is provided as a separate intermediate product. According to a first alternative, the calcium oxide coming from the first step is allowed to cool to ambient temperature and is stored before being used in the second step.

According to a second alternative, the calcium oxide is withdrawn from the first reactor at a first temperature and is introduced into the second rector at a second temperature that is <100° C. below the first temperature. In particular, both reactors may operate in cascade to make sure that the materials entering the second reactor retain heat so as to reduce the energy consumption of the second reactor.

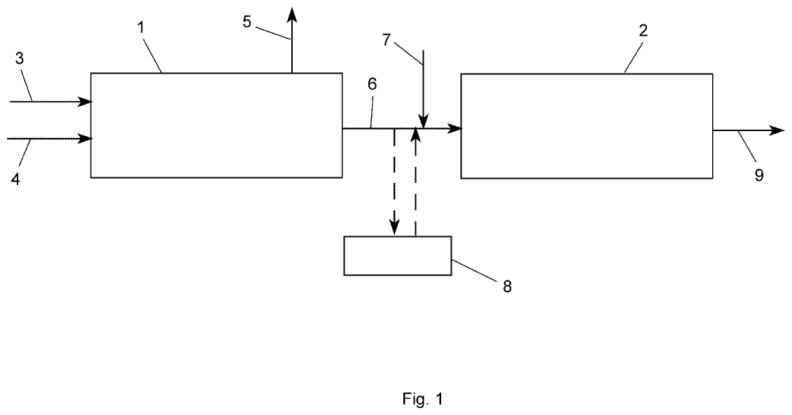

The invention will now be described by means of an exemplary embodiment illustrated in FIG. 1. The figure shows a first reactor 1 and a second reactor 2. The first step of the method according to the invention is carried out in the first reactor 1. The second step of the method according to the invention is carried out in the second reactor 2.

In the first step, a source of calcium sulfate 3 is introduced into the first reactor 1 and is calcined in the presence of a reducing agent 4 in order to obtain calcium oxide and sulfur dioxide at a temperature of 700-1300° C. As a result, calcium oxide 6 and sulfur dioxide 5 are obtained, which are separately withdrawn from the first reactor 1. Alternatively, calcium oxide and sulfur dioxide are withdrawn from the first reactor 1 together and separated in an external separator.

In the second step, silica, alumina and iron oxide 7 are added to the calcium oxide 6 to obtain a raw material mixture, which is calcined in the second reactor 2 in order to obtain cement clinker 9.

If desired, the calcium oxide 6 coming from the first reactor 1 or at least a partial amount thereof, may be stored in a storage 8 and used in other applications or introduced into the second reactor 2 at a later point in time.

1. A method of producing cement clinker from a source of calcium sulfate, comprising
a first step of calcining the source of calcium sulfate in the presence of a reducing agent in a first reactor to obtain calcium oxide and sulfur dioxide and withdrawing the calcium oxide from the first reactor, and subsequently
a second step of adding silica, alumina and iron oxide containing materials to the calcium oxide to obtain a raw material mixture and calcining the raw material mixture in a second rector to obtain cement clinker.

2. The method according to claim 1, wherein the calcination of the first step is carried out at a temperature of 700-1300° C. and the calcination of the second step is carried out at a temperature of 1340-1450° C.

3. The method according to claim 1, wherein the source of calcium sulfate is gypsum, anhydrite, hemihydrate, waste calcium sulfate and/or phosphogypsum.

4. The method according to claim 1, wherein the source of calcium sulfate is introduced into the first reactor in the form of a powder.

5. The method according to claim 1, wherein the source of calcium sulfate is dried to a water content of <2 wt. -% before being introduced into the first reactor.

6. The method according to claim 1, wherein the first step is carried out in a reducing atmosphere.

7. The method according to claim 1, wherein a source of carbon in solid form, a metal powder, or hydrogen, is used as the reducing agent.

8. The method according to claim 1, wherein the first reactor is designed as a flash calciner, rotary calciner, fluidized bed reactor or shaft reactor.

9. The method according to claim 1, wherein the second reactor is designed as a rotary kiln.

10. The method according to claim 1, wherein the sulfur dioxide obtained in the first step is separated from the calcium oxide, before the calcium oxide is fed to the second step.

11. The method according to claim 1, wherein the calcium oxide coming from the first step is allowed to cool to ambient temperature and is stored before being used in the second step.

12. The method according to claim 1, wherein the calcium oxide is withdrawn from the first reactor at a first temperature and is introduced into the second rector at a second temperature that is <100° C. below the first temperature.

13. The method according to claim 1, wherein the silica, alumina and iron oxide containing materials comprise recycled or waste materials.

14. The method according to claim 13, wherein the recycled or waste materials are selected from any of the following materials: mineral waste materials from construction and demolition, recycled aggregates, recycled bricks, coal ashes, or steel slags.

15. The method according to claim 2, wherein the second step is carried out at higher temperature than the first step.

16. The method according to claim 4, wherein the powder has a maximum particle size of 300 pm measured by sieving.

17. The method according to claim 6, wherein the oxygen content is below 0.7 vol. -%.

18. The method according to claim 7, wherein the source of carbon is coal in powder form, or wherein the metal powder comprises calcium, aluminum, silicium, iron, or mixtures thereof.

19. The method according to claim 14, wherein the waste materials from construction and demolition comprise concrete demolition waste.
